(19) United States
(12) Patent Application Publication
(10) Pub. No.: US 2024/0251480 A1
(43) Pub. Date: Jul. 25, 2024

(54) SELF-TEMPERATURE-LIMITING ELECTRIC HEATING FILM AND PREPARATION METHOD THEREFOR

(71) Applicant: ZHONGSHANG TECH (BEIJING) CO., LTD, Beijing (CN)

(72) Inventors: Wei ZHANG, Beijing (CN); Nan BAI, Beijing (CN); Menghai WANG, Beijing (CN); Yongzhen WANG, Beijing (CN)

(73) Assignee: ZHONGSHANG TECH (BEIJING) CO., LTD, Beijing (CN)

(21) Appl. No.: 18/592,756

(22) Filed: Mar. 1, 2024

Related U.S. Application Data
(63) Continuation of application No. PCT/CN2022/116722, filed on Sep. 2, 2022.

(30) Foreign Application Priority Data
Sep. 3, 2021 (CN) 2021110306437
Mar. 23, 2022 (CN) 2022102851968

(51) Int. Cl. H05B 3/14; H05B 3/16

(52) U.S. Cl. CPC H05B 3/141; H05B 3/16; H05B 2203/013; H05B 2203/017

(57) ABSTRACT

Disclosed is a self-temperature-limiting electric heating film and a preparation method therefor. The self-temperature-limiting electric heating film comprises a substrate, an electric heating layer arranged on the substrate, and two electrodes arranged on the electric heating layer. The electric heating layer comprises a heating block and a temperature-limiting block connected to the heating block. The temperature-limiting block comprises titanate and a substrate containing a first doping element, and the temperature-limiting block is used for limiting the temperature of the electric heating film. The first doping element is a rare earth element. The substance containing the first doping element is an elementary substance containing the first doping element or a compound containing the first doping element. Compared with macromolecular temperature-limiting materials, the temperature-limiting block prepared in the invention is easy to prepare, low in price, and stable long service life and reducing a specific application scenario to reduce energy consumption.

### CROSS-REFERENCE TO RELATED APPLICATIONS

The application claims priority to Chinese patent application No. 2021110306437, filed on Sep. 3, 2021, and No. 2022102851968, filed on Mar. 23, 2022, the entire contents of which are incorporated herein by reference.

### TECHNICAL FIELD

The invention discloses a self-temperature-limiting electric heating film and a preparation method therefor, and belongs to the technical field of electric heating films.

### BACKGROUND

Electric heating films are widely applied to the fields of electric heating and heating because of their advantages of small occupied space, high electric heating efficiency, environmental friendliness and the like.

In the prior art, to realize energy saving of electric heating films and guarantee the safety of electric heating films, macromolecular polymers are added to materials of electric heating films to limit the temperature. Specifically, macromolecular polymers doped with carbon powder are extruded to obtain electric heating films. The carbon powder in the electric heating films forms carbon chains to realize electric conduction and heat generation; however, the macromolecular polymers will expand when heated, and at this moment, the carbon chains will be broken to form a high resistance, that is, the temperature is limited by regulating the resistance.

When macromolecular materials are used as temperature-limiting materials, because of the material and structural mechanism of organic polymers, the room-temperature resistance of the materials will increase irreversibly with the increase of the service time and current impacts, which will compromise the service life of the temperature-limiting materials, thus reducing the safety performance of electric heating films, making it difficult to save energy, and increasing heating costs.

### SUMMARY

The objective of the application is to provide a self-temperature-limiting electric heating film and a preparation method therefor to solve the technical problems of low safety and high energy consumption of electric heating films caused by the short service life of temperature-limiting materials in the prior art.

In a first aspect, the invention provides a self-temperature-limiting electric heating film, comprising a substrate, an electric heating layer arranged on the substrate, and two electrodes arranged on the electric heating layer;

the electric heating layer comprises a heating block and a temperature-limiting block connected to the heating block;

the temperature-limiting block comprises titanate and a substance containing a first doping element, and the temperature-limiting block is used for limiting a temperature of the electric heating film;

the first doping element is a rare earth element;

the substance containing the first doping element is an elementary substance containing the first doping element or a compound containing the first doping element.

Preferably, the temperature-limiting block is arranged on the substrate;

the heating block is arranged on the temperature-limiting block;

the two electrodes are arranged on the heating block.

Preferably, the electric heating layer comprises a heating block and two temperature-limiting blocks;

the heating block and the two temperature-limiting blocks are all arranged on the substrate, and the heating block is arranged between the two temperature-limiting blocks;

the two electrodes are arranged on the two temperature-limiting blocks respectively.

Preferably, the electric heating layer comprises a temperature-limiting block and two heating blocks;

the temperature-limiting block and the heating blocks are all arranged on the substrate, and the temperature-limiting block is arranged between the two heating blocks;

the two electrodes are arranged on the two heating blocks respectively.

Preferably, a mass ratio of the substance containing the first doping element and the titanate is 0.0015-0.003:1.

Preferably, the temperature limiting block further comprises a substance containing a second doping element, and the second doping element comprises at least one of a rare earth element, manganese, calcium and aluminum;

a mass ratio of the substance containing the second doping element and the titanate is 0:0.3-1;

the substance containing the second doping element is an elementary substance containing the second doping element or a compound containing the second doping element.

Preferably, the titanate is barium titanate, strontium titanate, barium strontium titanate or strontium lead titanate;

the rare earth element is at least one of lanthanum, cerium, neodymium, yttrium, praseodymium and samarium;

the substrate is made from glass, ceramic or plastic.

In a second aspect, the invention provides a preparation method for the self-temperature-limiting electric heating film, comprising:

depositing a substance containing a first doping element and titanate on a substrate to prepare a temperature-limiting block;

plating a heating block on a surface or side edge of the temperature-limiting block; and

arranging electrodes on the temperature-limiting block or the heating block to obtain the self-temperature-limiting electric heating film;

wherein, a mass ratio of the substance containing the first doping element and the titanate is 0.0015-0.003:1.

Preferably, the second temperature-limiting block further comprises a substance containing a second doping element;

correspondingly, depositing a substance containing a first doping element and titanate on a substrate to prepare a temperature-limiting block specifically comprises:

depositing the substance containing the first doping element, the substance containing the second doping element, and the titanate on the substrate to prepare the temperature-limiting block;

a mass ratio of the substance containing the second doping element and the titanate is 0-0.3:1.

Preferably, depositing a substance containing a first doping element and titanate on a substrate to prepare a temperature-limiting block specifically comprises:

depositing the substance containing the first doping element and the titanate on the substrate by one of a radio-frequency magneton sputtering method, a pulsed laser deposition method, a vacuum evaporation method, a molecular beam epitaxy method, a sol-gel method, a chemical vapor deposition method and a hydrothermal method to prepare the temperature-limiting block.

Further, electric heating elements in the prior art mainly comprise alloy electric heating wires and carbon-based electric heating films. The alloy electric heating wires, as traditional electric heating elements, are linear heat sources and have the drawbacks of being small in heat dissipation area, prone to breakage, poor in seismic performance and the like. Moreover, because part of electric energy of the alloy electric heating wires may be converted into light energy, the electric energy conversion efficiency is low and is only about 60%.

The carbon-based electric heating films, as organic non-transparent electric heating films, are prepared by coating the surface of an insulating material with a conductive coating by spraying or silk-screen printing, and as plane heat sources, can realize uniform heat dissipation and high electric energy conversion efficiency, thus gradually replacing the alloy electric heating wires. However, a large quantity of organic substances is used for preparing the carbon-based electric heating films, these organic substances will lead to severe power attenuation of the carbon-based electric heating films, result in environmental pollution and do harm to human health in preparation and use. In addition, because of two-sided heat dissipation of the carbon-based electric heating films, the heat utilization rate of the side away from the heated surface is low, leading to a waste of resources.

Therefore, an infrared reflecting layer is arranged on the electric heating film of the invention;

the heating block is arranged on a first surface of the substrate;

a heating material of the heating block is metal-oxide-semiconductor-heating material;

the infrared reflecting layer is arranged on a second surface of the substrate and is used for directionally reflecting heat transferred to the substrate to the heating block.

Preferably, the infrared reflecting layer comprises a first film and a second film;

the first film is arranged on the second surface of the substrate;

the second film is arranged on a surface of the first film;

a refraction index of the first film is greater than a refraction index of the second film.

Preferably, the self-temperature-limiting electric heating film further comprises a barrier layer;

the barrier layer is arranged between the heating block and the substrate and is used for preventing impurities and water vapor generated by the substrate from entering the heating block.

Preferably, the self-temperature-limiting electric heating film further comprises a smoothing layer;

the smoothing layer is arranged between the substrate and the barrier layer and is used for reducing roughness of the substrate.

Preferably, the self-temperature-limiting electric heating film further comprises a heat-resistant layer;

the heat-resistant layer is arranged between the smoothing layer and the barrier layer and is used for reducing a coefficient of thermal expansion of the substrate.

A preparation method for the electric heating film comprising the infrared reflecting layer comprises:

plating a metal-oxide-semiconductor-heating material on a first surface of the substrate to form a heating block; and

plating an infrared reflecting layer on a second surface of the substrate, wherein the infrared reflecting layer is used for reflecting heat transferred to the substrate to the heating block.

Preferably, plating an infrared reflecting layer on a second surface of the substrate specifically comprises:

plating a first film on the second surface of the substrate; and

plating a second film on a surface of the first film;

wherein, a refraction index of the first film is greater than a refraction index of the second film.

Preferably, plating a first film on the second surface of the substrate specifically comprises:

plating the first film on the second surface of the substrate by a magnetron sputtering method;

plating a second film on a surface of the first film specifically comprises:

plating the second film on the surface of the first film by an electronic beam evaporation method.

Preferably, before plating a metal-oxide-semiconductor-heating material on a first surface of the substrate to form a heating block, the preparation method further comprises:

plating an oxide of a group IVA element on the first surface of the substrate to form a barrier layer;

correspondingly, plating a metal-oxide-semiconductor-heating material on a first surface of the substrate to form a heating block specifically comprises:

plating the metal-oxide-semiconductor-heating material on the barrier layer to form the heating block.

Preferably, before plating an oxide of a group IVA element on the first surface of the substrate to form a barrier layer, the preparation method further comprises:

coating acrylate on the first surface of the substrate to form a heat-resistant layer;

correspondingly, plating an oxide of a group IVA element on the first surface of the substrate to form a barrier layer is specifically:

plating the oxide of the group IVA element on the heat-resistant layer to form the barrier layer.

Compared with the prior art, the self-temperature-limiting electric heating film and preparation method therefor have the following beneficial effects:

Compared with macromolecular temperature-limiting materials, the temperature-limiting block prepared in the invention is easy to prepare, low in price, stable in room-temperature resistance that will not increase with the increase of current impacts, and capable of effectively prolonging the service life of the self-temperature-limiting electric heating film and reducing unnecessary heating under a specific application scenario to reduce energy consumption, and has the advantages of being simple in structure, small in occupied space, and high in safety performance.

The heating material of the heating block in the invention is the metal-oxide-semiconductor-heating (MOSH) material, which has stable chemical properties and a structure that will not change after being heated for a long time, and is high in uniformity, so the heating block prepared from the MOSH material can realize uniform heating and has a low-temperature radiation deviation of ±1° C. In addition, the MOSH material has the advantages of low resistance and high transmittance, so the electric heating film prepared using the MOSH material has high electrothermal conversion performance and a transmittance over 80%. In the invention, materials used for preparing the electric heating material are inorganic substances, so the environmental pollution will not be caused during the preparation process, odors harmful to human health will not be released in use, and the problem of severe power attenuation of carbon-based electric heating films caused by the use of organic substances is avoided.

Further, the infrared reflecting layer is arranged in the electric heating film of the invention and can directionally reflect heat transferred to the substrate from the heating block back to the heating block to concentrate heat to one side rather than two sides of the heating block, such that the loss rate of heat is decreased, and the utilization rate of heat is greatly increased, thus avoiding a waste of resources.

### BRIEF DESCRIPTION OF DRAWINGS

FIG. 1 is an overall structural diagram of a self-temperature-limiting electric heating film according to one embodiment of the invention;

FIG. 2 is a schematic diagram of a first structure of the self-temperature-limiting electric heating film according to one embodiment of the invention;

FIG. 3 is a schematic diagram of a second structure of the self-temperature-limiting electric heating film according to one embodiment of the invention;

FIG. 4 is a schematic diagram of a third structure of the self-temperature-limiting electric heating film according to one embodiment of the invention;

FIG. 5 is an overall flow diagram of a preparation method for the self-temperature-limiting electric heating film according to one embodiment of the invention;

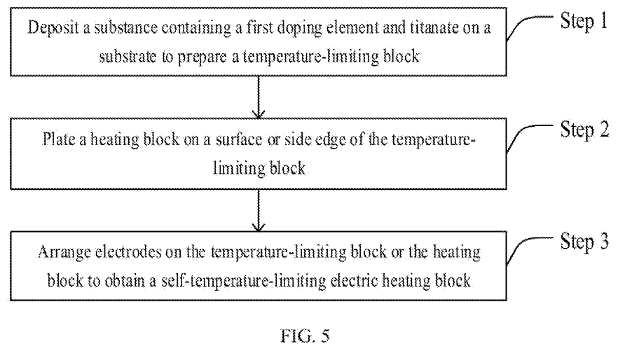

FIG. 6 is a schematic diagram of a result obtained by powering on a self-temperature-limiting electric heating film prepared in Embodiment 1 of the invention for aging;

FIG. 7 is a schematic diagram of a result obtained by powering on a self-temperature-limiting electric heating film prepared in Embodiment 2 of the invention for aging;

FIG. 8 is a schematic diagram of a result obtained by powering on a self-temperature-limiting electric heating film prepared in Embodiment 3 of the invention for aging;

FIG. 9 is a schematic diagram of a result obtained by powering on a self-temperature-limiting electric heating film prepared in Embodiment 4 of the invention for aging;

FIG. 10 is a schematic diagram of a result obtained by powering on a self-temperature-limiting electric heating film prepared in Embodiment 5 of the invention for aging;

FIG. 11 is a schematic diagram of a result obtained by powering on a self-temperature-limiting electric heating film prepared in Embodiment 6 of the invention for aging.

In the FIGS.: 1, substrate; 2, electric heating layer; 21, temperature-limiting block; 22, heating block; 3, electrode.

### DETAILED DESCRIPTION OF THE EMBODIMENTS

In the following description, specific details such as specific system structures and techniques are provided for the purpose of explaining the invention rather than limiting the invention, so as to gain a thorough understanding of the embodiments of the invention. However, those skilled in the art should appreciate that the invention can also be implemented in other embodiments without these specific details. In other cases, detailed descriptions of well-known systems, devices, circuits and methods are avoided to ensure that the invention can be described without being interfered by unnecessary details.

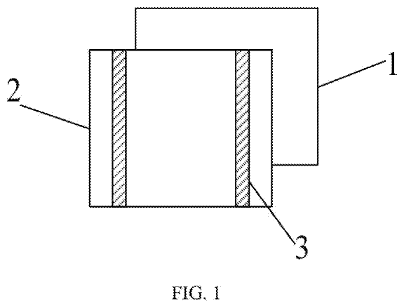

As shown in FIG. 1-FIG. 4 which illustrate one structure of a self-temperature-limiting electric heating film provided by the embodiments of the invention, the self-temperature-limiting electric heating film comprises a substrate 1, an electric heating layer 2 arranged on the substrate 1, and two electrodes 3 arranged on the electric heating layer 2; wherein, the substrate 1 is made from glass, ceramic or plastic, and the plastic may specifically be PET or PI.

In the embodiments of the invention, the electric heating layer 2 comprises a temperature-limiting block 21 and a heating block 22 connected to the temperature-limiting block 21, and the temperature-limiting block 21 is used for limiting the temperature of the electric heating film to the Curie temperature.

Wherein, the temperature-limiting block 21 comprises titanate and a substance containing a first doping element. Specifically, the titanate is barium titanate, strontium titanate, barium strontium titanate or strontium lead titanate; the first doping element is a rare earth element, which is specifically at least one of lanthanum, cerium, neodymium, yttrium, praseodymium and samarium; and the substance containing the first doping element is specifically an elementary substance containing the first doping element or a compound containing the first doping element.

In the embodiments of the invention, the heating block 22 is made from a semiconductor heating material such as a MOSH material, and more specifically, is one or more of tin antimony oxide, indium tin oxide, aluminum zinc oxide, gallium zinc oxide and indium zinc oxide. The MOSH material has stable in chemical properties and a structure that will not change after being heated for a long time, and is high in uniformity, and a semiconductor electric heating film prepared using the MOSH material can realize uniform heating and has a low-temperature radiation deviation of ±1° C. In addition, the MOSH material has the advantages of low resistance and high transmittance, so the heating block prepared from the MOSH material has high electrothermal conversion performance and a transmittance over 80%. In the invention, materials used for preparing the heating block are inorganic substances, so environmental pollution will not be caused during the preparation process, odors harmful to human health will not be released in use, and the problem of severe power attenuation is avoided.

In the invention, the elementary substance containing the first doping rare earth element or the compound containing the first doping rare earth element is added to titanate to change the microstructure of the titanate, such that the prepared temperature-limiting block 21 has a specific Curie temperature; when the temperature reaches the Curie temperature of the temperature-limiting block 21, the resistance of the temperature-limiting block 21 will increase sharply, and the current of the heating block 22 connected to the temperature-limiting block 21 is limited, thus maintaining the temperature of the electric heating film in the invention at a specific temperature. The self-temperature-limiting electric heating film provided by the invention can reduce unnecessary heating in specific application scenarios to reduce energy consumption and has the advantages of being simple in structure, small in occupied space and high in safety performance.

In the invention, the temperature-limiting block 21 and the heating block 22 are prepared separately, thus guaranteeing the temperature-limiting performance of the temperature-limiting block 21 and the heating performance of the heating block 22, and prolonging the service life of the self-temperature-limiting electric heating film composed of the temperature-limiting block 21 and the heating block 22.

The self-temperature-limiting electric heating film in the embodiments of the invention may be of multiple structures, and only three structures of the self-temperature-limiting electric heating film are illustrated in this embodiment.

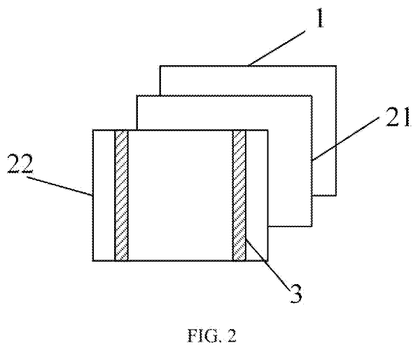

A first specific structure of the self-temperature-limiting electric heating film in the invention is a film layer structure. As shown in FIG. 2, the temperature-limiting block 21 is arranged on the substrate 1, the heating block 22 is arranged on the temperature-limiting block 21, and the two electrodes 3 are arranged on the heating block 22. In this structure, the temperature-limiting block 21 and the heating block 22 are connected in parallel, and when the temperature-limiting block 21 reaches the Curie temperature, the overall resistance of the parallel connection structure will increase, thus slowly limiting the temperature.

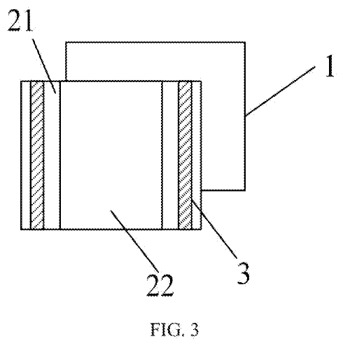

A second specific structure of the self-temperature-limiting electric heating film in the invention is a film stack structure. As shown in FIG. 3, the electrical heating layer 2 specifically comprises a heating block 22 and two limiting blocks 21; the heating block 22 and the temperature-limiting blocks 21 are all arranged on the substrate 1, and the heating block 22 is located between the two temperature-limiting blocks 21; and the two electrodes 3 are arranged on the two temperature-limiting blocks 21 respectively. In this structure, the temperature-limiting blocks 21 and the heating block 22 are connected in series, and when the temperature-limiting blocks 21 reach the Curie temperature, the overall resistance of the series connection structure will increase, thus realizing quick self-temperature-limiting.

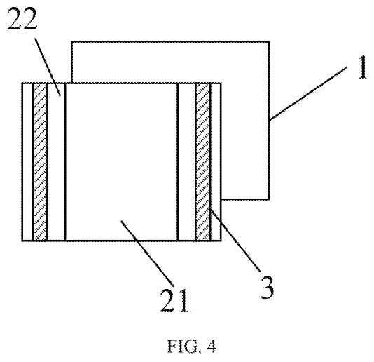

A third specific structure of the self-temperature-limiting electric heating film in the invention is a film stack structure. As shown in FIG. 4, the electric heating layer 2 specifically comprises a temperature-limiting block 21 and two heating blocks 22; the temperature-limiting block 21 and the heating blocks 22 are all arranged on the substrate 1, and the temperature-limiting block 21 is arranged between the two heating blocks 22; and the two electrodes 3 are arranged on the two heating blocks 22 respectively. In this structure, the temperature-limiting block 21 and the heating blocks 22 are connected in series, and when the temperature-limiting block 21 reaches the Curie temperature, the overall resistance of the series connection structure will increase, thus realizing quick self-temperature-limiting.

In the embodiments of the invention, the mass ratio of the elementary substance containing the first doping element or the compound containing the first doping element and the titanate is 0.0015-0.003:1. The temperature-limiting block 21 prepared according to such a mass ratio has a good Curie temperature, resistance rise ratio and room-temperature resistivity, such that the self-temperature-limiting electric heating film prepared using the temperature-limiting block can realize quick temperature limiting, has a longer service life, and solves the problem that the service life of macromolecular materials, used as temperature-limiting materials, will be compromised due to an irreversible increase of the room-temperature resistance of the materials with the increase of the service time and current impacts.

Further, in the embodiments of the invention, the temperature-limiting block 21 further comprises a substance containing a second doping element, and the second doping element is at least one of a rare earth element, manganese, calcium and aluminum; and the mass ratio of the substance containing the second doping element and the titanate is 0-0.3:1. Wherein, the rare earth element is at least one of lanthanum, cerium, neodymium, yttrium, praseodymium and samarium. The substance containing the second doping element is specifically an elementary substance containing the second doping element or a compound containing the second doping element.

By adding the substance containing the second doping element, the Curie temperature, resistance rise ratio and room-temperature resistivity of the temperature-limiting block 21 in the embodiments of the invention are optimized, such that the self-temperature-limiting electric heating film prepared using the temperature-limiting block 21 can realize quick temperature limiting and has a longer service life.

In a second aspect, the invention provides a preparation method for a self-temperature-limiting electric heating film, comprising:

Step 1: a substance containing a first doping element and titanate are deposited on a substrate 1 to prepare a temperature-limiting block 21, wherein the mass ratio of the substance containing the first doping element and the titanate is 0.0015-0.003:1. Specifically:

under a vacuum condition, the substance containing the first doping element (an elementary substance containing the first doping element or a compound containing the first doping element) and the titanate are deposited on the substrate 1 by physical methods (a radio-frequency magneton sputtering method, a pulsed laser deposition method, a vacuum evaporation method and a molecular beam epitaxy method) or chemical methods (a sol-gel method, a chemical vapor deposition method and a hydrothermal method) to prepare the temperature-limiting block 21.

When the physical method is used for preparing the temperature-limiting block 21, a target prepared by mixing the elementary substance or compound containing the first doping element and the titanate is used; or, a target of the elementary substance or compound containing the first doping element and a target of the titanate are prepared separately, and then the target of the elementary substance or compound containing the first doping element and the target of the titanate are deposited by one of the above physical methods to prepare the temperature-limiting bock 21. By separately preparing and then depositing the target of the elementary substance or compound containing the first doping element and the target of the titanate, the targets are stable, thus guaranteeing the stability of the temperature-limiting performance of the prepared temperature-limiting block.

Step 2, a heating block 22 is plated on a surface or side edge of the temperature-limiting block 21.

Step 3, electrodes 3 are arranged on the temperature-limiting block 21 or the heating block 22 to obtain a self-temperature-limiting electric heating film.

In the embodiments of the invention, the temperature-limiting block further comprises a substance containing a second doping element, wherein the substance containing the second doping element is specifically an elementary substance containing the second doping element or a compound containing the second doping element. Correspondingly, in Step 1:

the substance containing the first doping element, the substance containing the second doping element and the titanate are deposited on the substrate 1 to prepare the temperature-limiting block 21; wherein, the mass ratio of the substance containing the second doping element and the titanate is 0-0.3:1.

In a case where the temperature-limiting block comprises the elementary substance or compound containing the second doping element, when a physical method is used for preparing the temperature-limiting block 21, a target prepared by mixing the elementary substance or compound containing the first doping element, the elementary substance or compound containing the second doping element and the titanate is used; or, a target of the elementary substance or compound containing the first doping element, a target of the elementary substance or compound containing the second doping element and a target of the titanate are prepared separately (or, the elementary substance or compound containing the first doping element and the elementary substance or compound containing the second doping element are mixed to prepare a target, and a target is prepared from the titanate), and then the target of the elementary substance or compound containing the first doping element, the target of the elementary substance or compound containing the second doping element and the target of the titanate are deposited by one of the above physical methods to prepare the temperature-limiting block 21. By separately preparing and then depositing the target of the elementary substance or compound containing the first doping element, the target of the elementary substance or compound containing the second doping element and the target of the titanate, the targets are stable, thus guaranteeing the stability of the temperature-limiting performance of the prepared temperature-limiting block.

To guarantee the structural stability of the prepared self-temperature-limiting electric heating film, before Step 1, the preparation method in the embodiments of the invention further comprises:

the substrate 1 is ultrasonically cleaned, purified with tap water, dried and then heated to 80-100° C., and then Step 1-Step 3 are performed to prepare the self-temperature-limiting electric heating film.

In the embodiments of the invention, the substrate 1 is made from glass, ceramic or plastic, wherein the plastic may be PET or PI.

The preparation method provided by the invention can prepare self-temperature-limiting electric heating films of three structures.

The preparation method for the self-temperature-limiting electric heating film of a first film layer structure comprises:

Step A, a substrate 1 is ultrasonically cleaned, purified with tap water, dried, and then heated to 80-100° C., preferably 90-100° C., further preferably 100° C.

Step B, under a vacuum condition, an elementary or compound containing a first doping element and titanate (or an elementary or compound containing a first doping element, an elementary or compound containing a second doping element, and titanate) are deposited on the substrate 1 to prepare a temperature-limiting block 21, wherein the thickness of the temperature-limiting block 21 is 5-120 nm, preferably 10-100 nm, more preferably 20-90 nm.

Wherein, the mass ratio of the elementary or compound containing the first doping element and the titanate is 0.0015-0.003:1, and the mass ratio of the elementary or compound containing the second doping element and the titanate is 0-0.3:1;

In this step, a specific method for deposition is one of physical methods (a radio-frequency magnetron sputtering method, a pulsed laser deposition method, a vacuum evaporation method and a molecular beam epitaxy method) or chemical methods (a sol-gel method, a chemical vapor deposition method and a hydrothermal method).

To prevent the performance of the heating block 22 and the performance of the temperature-limiting block 21 from being compromised due to interaction between the heating block 22 and the temperature-limiting block 21 in the heating process, a barrier layer is plated on the temperature-limiting block 21, the barrier layer is preferably made from silicon oxide, and the thickness of the barrier layer is 5-15 nm, preferably 8-10 nm, more preferably 10 nm.

Step C, an electrically conductive heating material is placed on an upper surface of the barrier layer to prepare a heating block 22, wherein the thickness of the heating block 22 is 5-120 nm, preferably 10-100 nm, more preferably 15-50 nm, most preferably 30 nm. The thickness of the heating block in the invention can be selected within said range as needed. A thick heating block can be prepared to guarantee the light transmittance.

Step D, silver paste is printed on the heating block 22, and after the silver paste is dried, copper strips are pasted to prepare electrodes 3, thus obtaining the self-temperature-limiting electric heating film.

The preparation method for the self-temperature-limiting electric heating film of a second film stack structure comprises:

Step A, a substrate 1 is ultrasonically cleaned, purified with tap water, dried and then heated to 80-100° C., preferably 90-100° C., more preferably 100° C.

Step B, under a vacuum condition, an elementary substance or compound containing a first doping element and titanate (or an elementary or compound containing a first doping element, an elementary or compound containing a second doping element, and titanate) are deposited on two opposite sides of a surface of the substrate 1 respectively to prepare films used as temperature-limiting blocks 21, and an electrically conductive heating material is plated between the two temperature-limiting blocks 21 prepare a heating block 22. The thickness of the temperature-limiting blocks 21 is 5-120 nm, preferably 10-100 nm, more preferably 20-90 nm. The thickness of the heating block is 5-120 nm, preferably 10-100 nm, more preferably 15-50nm, most preferably 30 nm. The thickness of the temperature-limiting blocks 21 and the thickness of the heating block 22 are the same or different.

Wherein, the mass ratio of the elementary substance or compound containing the first doping element and the titanate is 0.0015-0.003:1, and the mass ratio of the elementary substance or compound containing the second doping element and the titanate is 0-0.3:1.

In this step, a specific method for deposition is one of physical methods (a radio-frequency magnetron sputtering method, a pulsed laser deposition method, a vacuum evaporation method and a molecular beam epitaxy method) or chemical methods (a sol-gel method, a chemical vapor deposition method and a hydrothermal method).

Step C, silver paste is printed on the temperature-limiting blocks 21, and after the silver paste is dried, copper strips are pasted to prepare electrodes 3, thus obtaining the self-temperature-limiting electric heating film.

A preparation method for the self-temperature-limiting electric heating film of a third film stack structure comprises:

Step A, a substrate 1 is ultrasonically cleaned, purified with tap water, dried and then heated to 80-100° C., preferably 90-100° C., more preferably 100° C.

Step B, under a vacuum condition, an elementary or compound containing a first doping element and titanate (or an elementary or compound containing a first doping element, an elementary or compound containing a second doping element, and titanate) are deposited on the substrate 1 to prepare a film used as a temperature-limiting block 21, and an electrically conductive heating material is plated on two opposite sides of the temperature-limiting block 21 to prepare heating blocks 22. The thickness of the temperature-limiting block 21 is 5-120 nm, preferably 10-100 nm, more preferably 20-90 nm. The thickness of the heating blocks is 5-120 nm, preferably 10-100 nm, more preferably 15-50 nm, most preferably 30 nm. The thickness of the temperature-limiting block 21 and the thickness of the heating blocks 22 are the same or different.

Wherein, the mass ratio of the elementary substance or compound containing the first doping element and the titanate is 0.0015-0.003:1, and the mass ratio of the elementary substance or compound containing the first doping element and the titanate is 0-0.3:1.

In this step, a specific method for deposition is one of physical methods (a radio-frequency magnetron sputtering method, a pulsed laser deposition method, a vacuum evaporation method and a molecular beam epitaxy method) or chemical methods (a sol-gel method, a chemical vapor deposition method and a hydrothermal method).

Step C, silver paste is printed on the heating blocks 22, and after the silver paste is dried, copper strips are pasted to prepare electrodes 3, thus obtaining the self-temperature-limiting electric heating film.

The preparation method provided by the invention is simple; because the temperature of the preparation environment is relatively low, a substrate made from PET can be used to prepare a semitransparent self-temperature-limiting electric heating film, which is good in performance and stable in structure and solves the problem that existing inorganic ceramic temperature-limiting materials can only be deposited on high-temperature substrates.

After the self-temperature-limiting electric heating film prepared by the preparation method is powered on to be heated, the temperature of the self-temperature-limiting electric heating film will rise gradually; when the temperature of the self-temperature-limiting electric heating film rises to a specific temperature (the Curie temperature of the temperature-limiting block 21), the resistance will increase sharply, and the current will be limited, thus maintaining the temperature of the entire self-temperature-limiting electric heating film at about the specific temperature.

The self-temperature-limiting electric heating film provided by the invention can be used on the floor or wall of a building to function as a heating device, and can also be applied to a bathroom mirror or window glass to prevent condensation of the bathroom mirror or window glass. The self-temperature-limiting electric heating film provided by the invention can fulfill a satisfactory heating effect under a normal mains voltage and uses a few materials, thus greatly reducing the production cost.

Below, the preparation method for the self-temperature-limiting electric heating film provided by the invention will be described in detail and the performance of the self-temperature-limiting electric heating film of the invention will be verified with more specific embodiments.

### EMBODIMENT 1

(1) A substrate 1 was ultrasonically cleaned, then purified with tap water and then dried, wherein the substrate 1 was made from PET.
(2) A neodymium-containing compound (first compound) with a mass fraction being 0.2% that of barium titanate, a cerium-containing compound with a mass fraction being 0.4% of the barium titanate and a manganese-containing compound (second compound) with a mass fraction being 15.4% of the barium titanate were doped into the barium titanate to be pressed into a target. Preferably, neodymium in the neodymium-containing compound was pentavalent, cerium in the cerium-containing compound was trivalent, and manganese in the manganese-containing compound was bivalent.
(3) When the substrate 1 was heated to 80° C., the target with a thickness of 60 nm was plated on the substrate 1 by a magnetron sputtering method to obtain a temperature-limiting block 21.
(4) A SiO2 barrier layer with a thickness of 10 nm was plated on an upper surface of the temperature-limiting block 21.
(5) A heating block 22 with a thickness of 30 nm was plated on an upper surface of the barrier layer.
(6) Silver paste was screen-printed at a proper position of the heating block 22 and then dried, and copper strips were pasted to prepare electrodes 3, thus obtaining a self-temperature-limiting electric heating film.

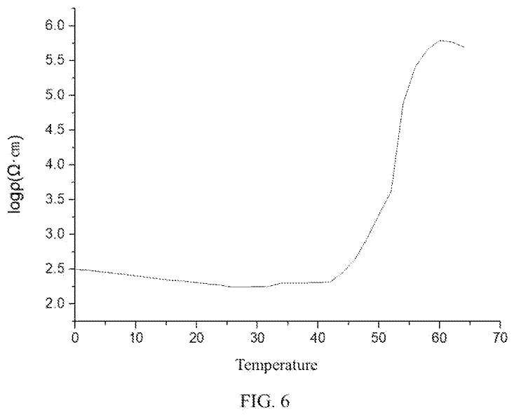

A result obtained by powering on the self-temperature-limiting electric heating film for aging is shown in FIG. 6. When the temperature of the self-temperature-limiting electric heating film rises to about 60° C., the resistance of the temperature-limiting block 21 increases sharply to limit the temperature; when the temperature of the self-temperature-limiting electric heating film falls below 60° C., the resistance of the temperature-limiting block 21 decreases, and the temperature of the self-temperature-limiting electric heating film rises again. In this way, the temperature of the self-temperature-limiting electric heating film is maintained at about 60° C.

### EMBODIMENT 2

(1) A substrate 1 was ultrasonically cleaned, then purified with tap water and then dried, wherein the substrate 1 was made from glass.
(2) An yttrium-containing compound (first compound) with a mass fraction being 0.19% of barium strontium titanate and a manganese-containing compound (second compound) with a mass fraction being 0.08% of the barium strontium titanate were doped into the barium strontium titanate to be pressed into a target. Preferably, yttrium in the yttrium-containing compound was trivalent, and manganese in the manganese-containing compound was bivalent.
(3) A heating block 22 with a thickness of 40 nm was plated on the substrate 1.
(4) When the substrate 1 was heated to 90° C., the target with a thickness of 30 nm was plated on two sides of the heating block 22 by a magnetron sputtering method to obtain temperature-limiting blocks 21.
(5) Silver paste was screen-printed on the temperature-limiting blocks 21 and then dried, and copper strips were pasted to prepare electrodes 3, thus obtaining a self-temperature-limiting electric heating film.

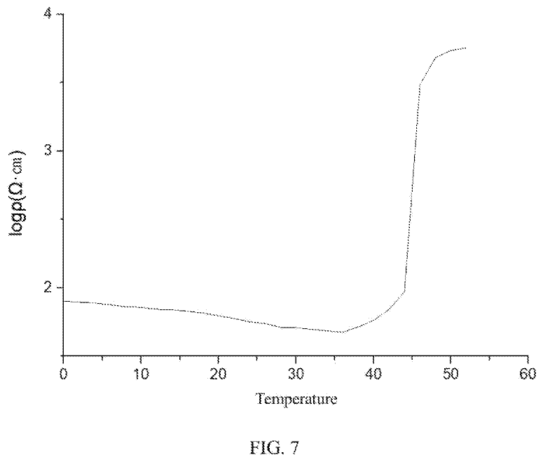

A result obtained by powering on the self-temperature-limiting electric heating film for aging is shown in FIG. 7. When the temperature of the self-temperature-limiting electric heating film rises to about 50° C., the resistance of the temperature-limiting blocks 21 increases sharply to limit the current across the heating block 22, such that the temperature of the self-temperature-limiting electric heating film is limited; when the temperature of the self-temperature-limiting electric heating film falls below 50° C., the resistance of the temperature-limiting blocks 21 decreases, and the temperature of the self-temperature-limiting electric heating film rises again. In this way, the temperature of the self-temperature-limiting electric heating film is maintained at about 50° C.

### EMBODIMENT 3

(1) A substrate 1 was ultrasonically cleaned, then purified with tap water and then dried, wherein the substrate 1 was made from ceramic.
(2) An yttrium-containing compound (first compound) with a mass fraction being 0.22% of barium strontium titanate and an aluminum-containing compound with a mass fraction being 27.13% of the barium strontium titanate were doped into the barium strontium titanate to be pressed into a target. Preferably, yttrium in the yttrium-containing compound was pentavalent, and aluminum in the aluminum-containing compound was trivalent.
(3) Silicon oxide with a thickness of 10 nm was plated on the substrate 1 to improve the adhesion of the substrate.
(4) When the substrate 1 was heated to 80° C., a resulting mixture with a thickness of 30 nm was deposited in the middle of the substrate 1 by a vapor deposition method to obtain a temperature-limiting block 21.
(5) A heating material with a thickness of 30 nm was plated on two sides of the temperature-limiting block 21 by a magnetron sputtering method and covered a surface of the substrate 1.
(6) Silver paste was screen-printed at proper positions of heating blocks 22 and then dried, and copper strips were pasted to prepare electrodes 3, thus obtaining a self-temperature-limiting electric heating film.

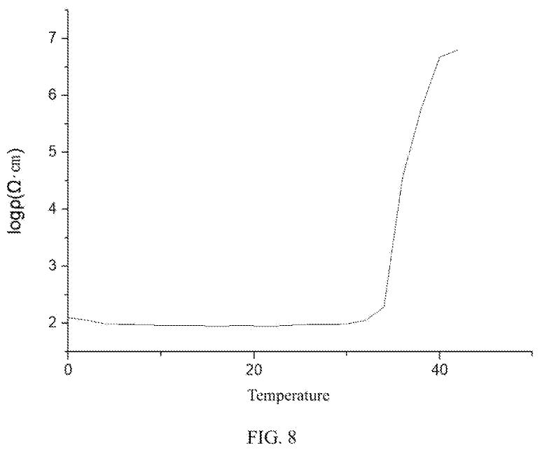

A result obtained by powering on the self-temperature-limiting electric heating film for aging is shown in FIG. 8. When the temperature of the self-temperature-limiting electric heating film rises to about 40° C., the resistance of the temperature-limiting block 21 increases sharply to cut off the current of an electric heating layer, such that the temperature of the self-temperature-limiting electric heating film is limited; when the temperature of the self-temperature-limiting electric heating film falls below 40° C., the resistance of the temperature-limiting blocks 21 decreases, and the temperature of the self-temperature-limiting electric heating film rises again. In this way, the temperature of the self-temperature-limiting electric heating film is maintained at about 40° C.

### EMBODIMENT 4

(1) A substrate 1 was ultrasonically cleaned, then purified with tap water and then dried, wherein the substrate 1 was made from PI.
(2) A lanthanum-containing compound (first compound) with a mass fraction being 0.15% of barium strontium titanate was mixed with the barium strontium titanate, a resulting mixture was pressed into a target. Preferably, lanthanum in the lanthanum-containing compound was trivalent.
(3) A heating block 22 with a thickness of 5 nm was plated on the substrate 1.
(4) When the substrate 1 was heated to 100° C., the target with a thickness of 20 nm was deposited on two sides of the heating block 22 on the substrate by a pulsed laser deposition method to obtain temperature-limiting blocks 21.
(5) Silver paste was screen-printed on the temperature-limiting blocks 21 and then dried, and then copper strips were pasted to prepare electrodes 3, thus obtaining the self-temperature-limiting electric heating film.

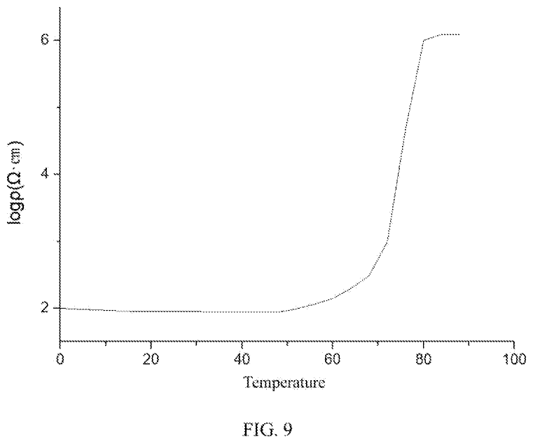

A result obtained by powering on the self-temperature-limiting electric heating film for aging is shown in FIG. 9. When the temperature of the self-temperature-limiting electric heating film rises to about 85° C., the resistance of the temperature-limiting blocks 21 increases sharply to limit the current across the heating block 22, such that the temperature of the self-temperature-limiting electric heating film is limited; when the temperature of the self-temperature-limiting electric heating film falls below 85° C., the resistance of the temperature-limiting blocks 21 decreases, and the temperature of the self-temperature-limiting electric heating film rises again. In this way, the temperature of the self-temperature-limiting electric heating film is maintained at about 85° C.

### EMBODIMENT 5

(1) A substrate 1 was ultrasonically cleaned, then purified with tap water and then dried, wherein the substrate 1 was made from ceramic.
(2) A target of a samarium-containing compound (first compound) with a mass fraction being 0.3% of barium strontium titanate was prepared; a target of a calcium-containing compound with a mass fraction being 10% of the barium strontium titanate and a cerium-containing compound (second compound) with a mass fraction being 20% of the barium strontium titanate was prepared; and a target of the barium strontium titanate was prepared. Preferably, samarium in the samarium-containing compound was trivalent, calcium in the calcium-containing compound was bivalent, and cerium in the cerium-containing compound was trivalent.
(3) A silicon oxide layer with a thickness of 8 nm was plated on the substrate 1 to improve the adhesion of the substrate.
(4) When the substrate 1 was heated to 80° C., the three targets with a thickness of 120 nm were deposited in the middle of the substrate 1 at the same time by a vacuum evaporation method to obtain a temperature-limiting block 21.
(5) A heating material with a thickness of 120 nm was plated on two sides of the temperature-limiting block 21 by a chemical vapor deposition method and covered a surface of the substrate 1.
(6) Silver paste was screen-printed at proper positions of heating blocks 22 and dried, and then copper strips were dried to prepare electrodes 3, thus obtaining a self-temperature-limiting electric heating film.

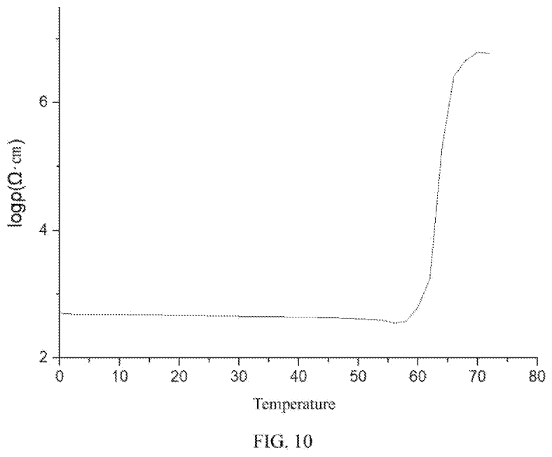

A result obtained by powering on the self-temperature-limiting electric heating film for aging is shown in FIG. 10. When the temperature of the self-temperature-limiting electric heating film rises to about 70° C., the resistance of the temperature-limiting blocks 21 increases sharply to cut off the current of an electric heating layer, such that the temperature of the self-temperature-limiting electric heating film is limited; when the temperature of the self-temperature-limiting electric heating film falls below 70° C., the resistance of the temperature-limiting block 21 decreases, and the temperature of the self-temperature-limiting electric heating film rises again. In this way, the temperature of the self-temperature-limiting electric heating film is maintained at about 70° C.

### EMBODIMENT 6

(1) A substrate 1 was ultrasonically cleaned, then purified with tap water and then dried, wherein the substrate 1 was made from glass.
(2) An yttrium-containing compound (first compound) with a mass fraction being 0.2% of barium strontium titanate and a manganese-containing compound (second compound) with a mass fraction being 5% of the barium strontium titanate were mixed with the barium strontium titanate, and a resulting mixture was pressed into a target. Preferably, yttrium in the yttrium-containing compound was trivalent, and manganese in the manganese-containing compound was bivalent.
(3) A heating block 22 with a thickness of 50 nm was plated on the substrate 1.
(4) When the substrate 1 was heated to 90° C., the target with a thickness of 80 nm was plated on two sides of the heating block 22 by a magnetron sputtering method to obtain temperature-limiting blocks 21.
(5) Silver paste was screen-printed on the temperature-limiting blocks 21 and dried, and then copper strips were dried to prepare electrodes 3, thus obtaining a self-temperature-limiting electric heating film.

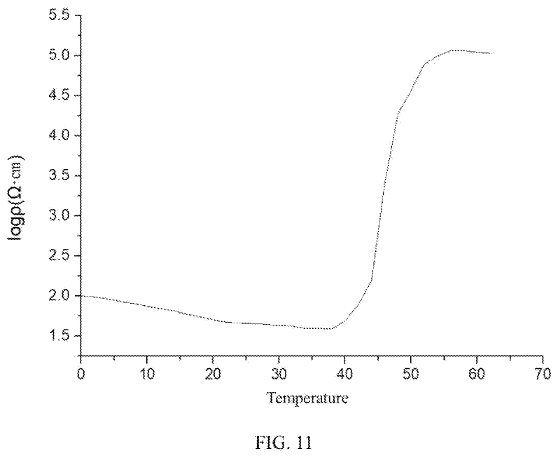

A result obtained by powering on the self-temperature-limiting electric heating film for aging is shown in FIG. 11. When the temperature of the self-temperature-limiting electric heating film rises to about 55° C., the resistance of the temperature-limiting blocks 21 increases sharply to limit the current across the heating block 22, such that the temperature of the self-temperature-limiting electric heating film is limited; when the temperature of the self-temperature-limiting electric heating film falls below 55° C., the resistance of the temperature-limiting blocks 21 decreases, and the temperature of the self-temperature-limiting electric heating film rises again. In this way, the temperature of the self-temperature-limiting electric heating film is maintained at about 55° C.

Compared with macromolecular temperature-limiting materials, the temperature-limiting block prepared in the invention is easy to prepare, low in price, stable in room-temperature resistance that will not increase with the increase of current impacts, and capable of effectively prolonging the service life of the self-temperature-limiting electric heating film; and the prepared self-temperature-limiting electric heating film is simple in overall structure.

Further, electric heating elements in the prior art mainly comprise alloy electric heating wires and carbon-based electric heating films. The alloy electric heating wires, as traditional electric heating elements, are linear heat sources and have the drawbacks of being small in heat dissipation area, prone to breakage, poor in seismic performance and the like. Moreover, because part of electric energy of the alloy electric heating wires may be converted into light energy, the electric energy conversion efficiency is low and is only about 60%.

The carbon-based electric heating films, as organic non-transparent electric heating films, are prepared by coating the surface of an insulating material with a conductive coating by spraying or silk-screen printing, and as plane heat sources, can realize uniform heat dissipation and high electric energy conversion efficiency, thus gradually replacing the alloy electric heating wires. However, a large quantity of organic substances is used for preparing the carbon-based electric heating films, these organic substances will lead to severe power attenuation of the carbon-based electric heating films, result in environmental pollution and do harm to human health in preparation and use. In addition, because of two-sided heat dissipation of the carbon-based electric heating films, the heat utilization rate of the side away from the heated surface is low, leading to a waste of resources.

Therefore, an infrared reflecting layer is arranged on the electric heating film in the invention.

The heating block 22 is arranged on a first surface of the substrate 1 and is used for generating heat.

A heating material of the heating block 22 is a MOSH material. In the embodiments of the invention, the MOSH material is one or more of tin antimony oxide, indium tin oxide, aluminum zinc oxide, gallium zinc oxide and indium zinc oxide.

Further, the thickness of the heating block 22 is 15-500 nm, specifically 15 nm, 18 nm, 20 nm, 40 nm, 80 nm, 125 nm, 200 nm, 275 nm, 350 nm, 400 nm or 500 nm, preferably 18 nm. When the heating block 22 is made from aluminum zinc oxide (AZO), the thickness of the heating block may reach 500 nm.

The MOSH material has stable in chemical properties and a structure that will not change after being heated for a long time, and is high in uniformity, and a semiconductor electric heating film prepared using the MOSH material can realize uniform heating and has a low-temperature radiation deviation of ±1° C. In addition, the MOSH material has the advantages of low resistance and high transmittance, so the heating block prepared from the MOSH material has high electrothermal conversion performance and a transmittance over 80%. In the invention, materials used for preparing the semiconductor electric heating film are inorganic substances, so environmental pollution will not be caused during the preparation process, odors harmful to human health will not be released in use, and the problem of severe power attenuation of carbon-based electric heating films caused by the use of organic substances is avoided.

In this embodiment, the infrared reflecting layer is arranged on a second surface of the substrate 1 and is used for directionally reflecting heat transferred to the substrate 1 to the heating block 22.

The infrared reflecting layer can directionally reflect heat transferred to the substrate 1 from the heating block 22 back to the heating block 22 to concentrate heat to one side rather than two sides of the heating block 22, such that the loss rate of heat is decreased, and the utilization rate of heat is greatly increased, thus avoiding a waste of resources.

Further, the infrared reflecting layer in this embodiment comprises a first film and a second film;

the first film is arranged on the second surface of the substrate 1;

the second film is arranged on one surface of the first film;

a refraction index of the first film is greater than a refraction index of the second film.

The infrared reflecting layer in this embodiment is a double-layer reflecting film; compared with single-layer reflecting layers, scattering of the double-layer reflecting film is greatly reduced, so it is ensured that far infrared light emitted by the heating block 22 is infrared-reflected to the maximum extent, the use of heat insulating materials is reduced, and the infrared reflecting layer is particularly suitable for application scenarios requiring a high transmittance and lacking heat insulating properties such as automotive glass. Moreover, the semiconductor heating film using the double-layer reflecting film is thin, occupies a small space, and is higher in practicability.

In this embodiment, the substrate 1 is made from a polyester film or a polyimide film, and has a thickness of 150-200 μm, specifically 150 μm, 160 μm, 175 μm, 188 μm or 200 μm, preferably 188 μm; the first film is a reflecting film with a high refraction index, is made from silicon or aluminum silicon, and has a thickness of 30-50 nm, specifically 30 nm, 40 nm or 50 nm, preferably 40 nm, and a refraction index of 2.6-3.69, specifically 2.6, 2.7, 2.87, 3.1, 3.5 or 3.69, preferably 2.87; and the second film is a reflecting film with a low refraction index, is made from magnesium fluoride or barium fluoride, and has a thickness of 50-120 nm, specifically 50 nm, 70 nm, 80 nm, 90 nm or 120 nm, preferably 80 nm, and a refraction index of 1.3-1.4, specifically 1.31, 1.33, 1.36, 1.38 or 1.40, preferably 1.38.

The infrared reflecting layer composed of the first film and the second film with the above parameters has a higher infrared reflecting capacity and a minimum heat loss. It should be noted that the embodiments of the invention have no limitation to the specific materials of the first film and the second film as long as an infrared reflecting effect is realized.

To preventing the heating efficiency and service life of the heating block 22 from being compromised by impurities diffused into the heating block 22 from the substrate 1 and water vapor seeping into the heating block 22 from the substrate 1, a barrier layer is arranged between the substrate 1 and the heating block 22 in this embodiment. The barrier layer in this embodiment is an oxide of a group IVA element, such as a silicon-containing oxide or a tin-containing oxide. In the embodiments of the invention, the barrier layer is specifically made from silicon oxide and has a thickness of 15-30 nm by way of example. Wherein, the thickness of the barrier layer may specifically be 15 nm, 18 nm, 22 nm, 24 nm, 25 nm, 28 nm or 30 nm, preferably 25 nm.

The barrier layer in this embodiment not only can prevent impurities and water vapor from entering the heating block 22, but also can make the coefficient of thermal expansion of the substrate 1 and the heating block 22 match the lattice constant, thus realizing reliable connection between all the layers and prolonging the service life.

The embodiments of the invention further disclose an electric heating film of another structure. The electric heating film of such a structure is further improved based on the electric heating film comprising the infrared reflecting layer.

Because the large surface coarseness of the substrate 1 will affect film plating of the barrier layer, the coarseness of the substrate 1 is reduced after the substrate 1 is cleaned in this embodiment. The coarseness of the substrate 1 is reduced using a smoothing layer. Specifically, a smoothing layer made from polyurethane is roller-coated on the substrate 1, the polyurethane is in a liquid state and smooths the substrate 1 by a leveling effect, and the coarseness of the substrate 1 is reduced after the polyurethane is roller-coated on the substrate 1, thus facilitating the adhesion of the barrier layer. Moreover, the polyurethane can resist impurities and can further prevent impurities and water vapor in the substrate 1 from being diffused into the heating block in conjunction with the barrier layer. The polyurethane in the embodiments of the invention may be polyester polyurethane or polyether urethane. The embodiments of the invention have no specific limitation to the specific material of the smoothing layer and the smoothing layer can be made from any materials that can reduce the coarseness of the substrate. The thickness of the smoothing layer is 2-5 μm, specifically 2 μm, 3 μm, 4 μm or 5 μm, preferably 3 μm.

The substrate 1 in this embodiment is made from a polyester film or a polyimide film, and in a high-temperature application scenario, the heat resistance of the substrate 1 is less than that of rigid substrates such as glass substrates. After being heated by the heating block 22 for a period of time, the substrate 1 will deform. Specifically, stress is concentrated to the center of the substrate 1, and the surface of the substrate 1 is depressed; however, because the expansion coefficient of the heating block 22 is small, the expansion coefficient of the substrate 1 will not match the expansion coefficient of the heating block 22 if the expansion coefficient of the substrate 1 is too large, and the whole film will bend and deform towards the side to which the heating block adheres, thus destroying the surface structure of the film.

Therefore, a heat-resistant layer is arranged between the smoothing layer and the barrier layer in this embodiment. The heat-resistant layer is prepared by roller-coating acrylate on the smoothing layer, such that the material of the substrate 1 can withstand a high temperature and the coefficient of thermal expansion of the material of the substrate 1 is reduced, thus improving the performance of the substrate 1. The acrylate in the embodiments of the invention may be any one compound of methyl acrylate, ethyl acrylate, butyl acrylate. The embodiments of the invention have no limitation to the specific material of the heat-resistant layer and the heat-resistant layer may be made from any materials that can withstand a high temperature and reduce the coefficient of thermal expansion of the material of the substrate 1. The thickness of the heat-resistant layer is 2-5 μm, specifically 2 μm, 3 μm, 4 μm or 5 μm, preferably 4 μm.

In the embodiments of the invention, the heating block made from the MOSH material has the advantages of uniform heating, low-temperature radiation deviation of ±1° C., high electrothermal conversion performance, high transmittance over 80%, long service life, and safety in use, and solves the problems of severe power attenuation, short service life, and pungent odors harmful to human health diffused in use and caused by organic substances of carbon-based electric heating films in the prior art. The infrared reflecting layer in the embodiments of the invention can directionally reflect heat transferred to the substrate from the heating block back to the heating block to concentrate heat to one side rather than two sides of the heating block, such that the loss rate of heat is decreased, and the utilization rate of heat is increased, thus avoiding a waste of resources.

The embodiments of the invention further disclose a preparation method for the electric heating film comprising the infrared reflecting layer, comprising:

Step 1, a MOSH material is plated on a first surface of the substrate to form a heating block. Specifically:

With the MOSH material as a target, the heating block is plated on the first surface of the substrate by a vacuum plating method; wherein, the vacuum plating method may be a magnetron sputtering method, an ion sputtering method or an electronic beam evaporation method. Because the magnetron sputtering method has the advantages of high deposition speed, low temperature rise of the substrate, small damage to the heating block, good bonding of the heating block and the substrate, high purity of the heating block, good compactness and good film formation uniformity, the heating block is plated on the first surface of the substrate preferably by the magnetron sputtering method in this embodiment.

The MOSH material may specifically be one or more of tin antimony oxide, indium tin oxide, aluminum zinc oxide, gallium zinc oxide and indium zinc oxide. The substrate is a polyester film or a polyimide film.

More specifically, a target adopted for magnetron sputtering is indium tin oxide (ITO), and the mass ratio of In2O3 and SnO2 in the target is 7:1-12:1, specifically 7:1, 8:1, 9:1, 10:1, 11:1 or 12:1, preferably 8:1; the vacuum pressure is greater than 1×10−3 Pa, the temperature of the substrate is normal temperature, the sputtering power surface density is 0.7-2.5 W/cm2, specifically 0.7 W/cm2, 0.9 W/cm2, 1.0 W/cm2, 1.2 W/cm2, 1.6 W/cm2, 2.0 W/cm2 or 2.5 W/cm2, and preferably 1 W/cm2; during the sputtering process, argon is introduced to serve as a protective gas, oxygen is introduced to serve as a reactant gas, the flow rate of the argon and the oxygen is 800-1200 ml/min, specifically 800 ml/min, 900 ml/min, 1000 ml/min, 1100 ml/min or 1200 ml/min; preferably, the flow rate of the argon is 1200 ml/min, and the flow rate of the oxygen is also 1200 ml/min; and the flow rate of the argon may be different from the flow rate of the oxygen. In this embodiment, the thickness of the heating block obtained by sputtering is 15-500 nm.

The connection method of temperature-limiting block and the electrodes and the connection method of the substrate and the heating block can be the same as those in the preparation method for the self-temperature-limiting electric heating film mentioned above, and will not be repeated here.

Step 2, an infrared reflecting layer is plated on a second surface of the substrate to reflect heat transferred to the substrate to the heating block. Specifically,

Step 2.1, a first film is plated on a second surface of the substrate by a vacuum plating method, wherein the vacuum plating method may be an ion sputtering method, a magnetron sputtering method or an electronic beam evaporation method. In this embodiment, the first film is plated by the magnetron sputtering method. A target adopted for magnetron sputtering is silicon or aluminum silicon, and the first film is made from silicon oxide. During the sputtering process, oxygen is introduced to serve as a reactant gas, and argon is introduced to serve as a protective gas. The first film is formed by sputtering at normal temperature.

More specifically, a 4N target (silicon or aluminum silicon) is adopted for sputtering to form the first film, wherein the doping content of aluminum is 0.3 wt %-1.5 wt %, specifically 0.3 wt %, 0.5 wt %, 0.7 wt %, 1.1 wt % or 1.5 wt %, preferably 0.5 wt %; the sputtering power surface density is 7-12 W/cm2, specifically 7 W/cm2, 8 W/cm2, 8.5 W/cm2, 9.5 W/cm2, 11 W/cm2 or 12 W/cm2, preferably 8.5 W/cm2. During the sputtering process, oxygen is introduced to serve as a reactant gas, argon is introduced to serve as a protective gas; the mass ratio of the argon and the oxygen is 5:1-15:1, specifically 5:1, 8:1, 10:1, 11:1, 13:1 or 15:1, preferably 10:1; the total flow rate of the argon and the oxygen is 100-500 ml/min, specifically 100 ml/min, 200 ml/min, 300 ml/min, 400 ml/min or 500 ml/min, preferably 500 ml/min; the vacuum pressure is greater than 1×10−3 Pa, and the temperature of the substrate is normal temperature; the thickness of the first film prepared on the surface of the substrate is 30 nm-50 nm, specifically 30 nm, 40 nm or 50 nm, preferably 40 nm, the first film is made from SiO2, and the refraction index of the first film is 2.6-3.69, specifically 2.6, 2.7, 2.87, 3.1, 3.5 or 3.69, preferably 2.87.

Step 2.2, a second film is plated on a surface, away from the substrate, of the first film, wherein the refraction index of the first film is greater than the refraction index of the second film;

Wherein, an ion sputtering method, a magnetron sputtering method or an electronic beam evaporation method is used for plating. In this embodiment, the electronic beam evaporation method is used for plating the second film, and a film material used for plating the second film is magnesium fluoride. Specifically, the vacuum pressure is greater than 1×10−3 Pa, the deposition rate is 1 Å/s-3 Å/s, specifically 1 Å/s, 1.5 Å/s, 2 Å/s, 2.5 Å/s or 3 Å/s, preferably 2.5 Å/s, and the temperature of the substrate is 80° C.-150° C., specifically 80° C., 90° C., 100° C., 110° C., 120° C., 130° C., 140° C. or 150° C., preferably 150° C.; a MgF2 film is coated on the first film, wherein the thickness of the MgF2 film is 50 nm-120 nm, specifically 50 nm, 70 nm, 80 nm, 90 nm or 120 nm, preferably 80 nm, and the refraction index of the MgF2 film is 1.3-1.4, specifically 1.31, 1.33, 1.36, 1.38 or 1.40, preferably 1.38.

To preventing the heating efficiency and service life of the heating block from being compromised by impurities diffused into the heating block from the substrate and water vapor seeping into the heating block from the substrate, before Step 1, the preparation method further comprises:

an oxide of a group IVA element is plated on the first surface of the substrate to form a barrier layer. Wherein, the oxide of the group IVA element is a silicon-containing oxide or a tin-containing oxide, and is plated by a magnetron sputtering method.

More specifically, a 4N silicon target is adopted, and the sputtering power surface density is 1-8 W/cm2, specifically 1 W/cm2, 1.5 W/cm2, 2 W/cm2, 2.5 W/cm2, 3 W/cm2, 3.5 W/cm2, 4 W/cm2, 4.5 W/cm2, 5 W/cm2, 5.5 W/cm2, 6 W/cm2, 6.5 W/cm2, 7 W/cm2, 7.5 W/cm2 or 8 W/cm2, preferably 1.5 W/cm2. During the sputtering process, oxygen is introduced to serve as a reactant gas, and argon is introduced to serve as a protective gas; the mass ratio of the argon and the oxygen is 10:1-20:1, specifically 10:1, 11:1, 12:1, 13:1, 14:1, 15:1, 16:1, 17:1, 18:1, 19:1 or 20:1, preferably 13:1; the flow rate of the oxygen is 50-100 ml/min, specifically 50 ml/min, 60 ml/min, 70 ml/min, 80 ml/min, 90 ml/min or 100 ml/min, preferably 80 ml/min; the flow rate of the argon is 300-800 ml/min, specifically 300 ml/min, 400 ml/min, 500 ml/min, 600 ml/min, 700 ml/min or 800 ml/min, preferably 800 ml/min; the vacuum pressure of the deposition process is greater than 1×10−3 Pa, and the temperature of the substrate is normal temperature; and a SiO2 layer is plated on the surface of the substrate, wherein the thickness of the SiO2 layer is 15 nm-30 nm, specifically 15 nm, 18 nm, 22 nm, 24 nm, 25 nm, 28 nm or 30 nm, preferably 23 nm.

Correspondingly, in Step 1, the MOSH material is plated on the first surface of the substrate to form a heating block. Specifically, the MOSH material is plated on the barrier layer to form the heating block.

Before the oxide of the group IVA element is plated on the first surface of the substrate to form the battier layer, the substrate needs to be cleaned. Specifically, the substrate is cleaned with a glass cleaning solution, an alkaline solution prepared from sodium hydroxide and deionized water respectively for 20 min-40 min, specifically 20 min, 30 min or 40 min, preferably 30 min, and then dried for later use.

A smoothing layer is plated on the cleaned substrate, wherein the thickness of the smoothing layer is 2-5 μm, specifically 2 μm, 3 μm, 4 μm or 5 μm, preferably 3 μm. The smoothing layer may be plated on the cleaned substrate by roller coating, and is dried at 100-150° C., specifically 100° C., 110° C., 120° C., 130° C., 140° C. or150° C., preferably 100° C. for 30-50 min, specifically 30 min, 40 min or 50 min, preferably 30 min.

After the smoothing layer is dried, a heat-resistant layer is coated on the smoothing layer. Specifically, the heat-resistant layer coated on the smoothing layer by roller coating, the thickness of the heat-resistant layer is 2-5 μm, specifically 2 μm, 3 μm, 4 μm or 5 μm, preferably 4 μm. Then, the heat-resistant layer is dried at a temperature of 90° C.-110° C., specifically 90° C., 100° C. or 110° C., preferably 100° C. After being dried, the heat-resistant layer is cured by ultraviolet irradiation for 15 min-30 min, specifically 15 min, 20 min, 25 min or 30 min, preferably 20 min, and exposure energy is 400 mJ-600 mJ, specifically 400 mJ, 450 mJ, 500 mJ, 550 mJ or 600 mJ, preferably 500 mJ.

After the heat-resistant layer is cured, plasms treatment is performed on the substrate to which the heat-resistant layer is adhered.

The preparation method for the electric heating film comprising the infrared reflecting layer is described below with reference to a more specific embodiment.

A preparation method for an electric heating film comprises:

Step 1, a substrate is cleaned.

In this embodiment, the substrate is made from a polyester (PET) film, has a thickness of 188 μm, and is cleaned with a glass cleaning solution, an alkaline solution prepared from sodium hydroxide, and deionized water respectively for 30 min and then dried for later use.

Step 2, a smoothing layer which has a thickness of 3 μm and is made from polyurethane is coated on a first surface of the cleaned substrate by roller coating and then dried at a temperature of 100° C. and an atmospheric pressure for 30 min.

Step 3, a heat-resistant layer which has a thickness of 4 μm and is made from acrylate is coated on the smoothing layer by roller coating, then dried at a temperature of 100° C. and an atmospheric pressure for 30 min, and then cured with ultraviolet light for 20 min, wherein the exposure energy is 500 mJ.

Step 4, to prevent the smoothing layer and the heat-resistant layer on the first surface of the substrate from being affected when an infrared reflecting layer is prepared on a second surface of the substrate, the smoothing layer and the heat-resistant layer are wrapped with aluminum foil. Then, magnetron sputtering is performed on the second surface of the substrate using a 4N aluminum silicon target to prepare a first film, wherein the thickness of the first film is 35 nm, the refraction index of the first film is 3.07, and the first film is an SiO2 film. During magnetron sputtering, the vacuum pressure of this deposition is greater than 1×10−3 Pa, the temperature of the substrate is normal temperature, the doping content of aluminum in the aluminum silicon target is 0.5 wt %, the sputtering power surface density is 8.5 W/cm2; during the sputtering process, oxygen is introduced to serve as a reactant gas, argon is introduced to serve as a protective gas, the flow rate of the oxygen and the argon is 300 ml/min, and the mass ratio of the argon and the oxygen is 10:1.

Step 5, a second film is prepared on the first film by an electronic beam evaporation method, wherein the second film has a thickness of 120 nm and a refraction index of 1.3 and is made from magnesium fluoride. During electronic beam evaporation, the vacuum degree of the substrate is less than 1×10−3 Pa, the deposition rate is 2Å/s, and the temperature of the substrate is 150° C.

Step 6, the aluminum foil wrapping around the smoothing layer and the heat-resistant layer is removed, and then the infrared reflecting layer is wrapped with aluminum foil to prevent the infrared reflecting layer from being affected when a heating block is prepared later.

Before the heating block is prepared, a silicon oxide (SiO2) barrier layer with a thickness of 23 nm is sputtered on the heat-resistant layer by magnetron sputtering; a 4N silicon target is used for sputtering, and the sputtering power surface density is 1.5 W/cm2; during the sputtering process, oxygen is introduced to serve as a reactant gas, the flow rate of the oxygen is 80 ml/min; argon is introduced to sever as a protective gas, and the flow rate of the argon is 800 ml/min; the mass ratio of the argon and the oxygen is 20:1.

Step 7, under the condition where the substrate is at normal temperature (5° C.-40° C.), a heating block with a thickness of 18 nm is sputtered on the barrier layer by magnetron sputtering, wherein a target used for sputtering is indium tin oxide (ITO), the mass ratio of In2O3 and SnO2 in the indium tin oxide is 8:1, and the sputtering power surface density is 1 W/cm2; during the sputtering process, argon is introduced to serve as a protective gas, and the flow rate of the argon is 1200 ml/min.

The electric heating film prepared by the above steps has the advantages of uniform heating, low-temperature radiation deviation of ±1° C., high electrothermal conversion efficiency, high transmittance over 80%, long service life, and safety in use.

Film layers used for preparing the electric heating film in the invention are all inorganic substances, so pollution is avoided during the preparation process; moreover, no organic substance is used, so odor harmful to human health will not be released in use, and the problem of severe power attenuation of carbon-based electric heating films caused by the use of organic substances is avoided.

The above embodiments are merely several ones of the application and are not intended to limit the application in any form. Although the application has been disclosed above with reference to preferred embodiments, the application is not limited to the above description. All transformations or modifications made by any skilled in the art according to the technical contents disclosed above are equivalent embodiments and should fall within the scope of the technical solution of the invention.

What is claimed is:

1. A self-temperature-limiting electric heating film, comprising a substrate, an electric heating layer arranged on the substrate, and two electrodes arranged on the electric heating layer;
the electric heating layer comprises a heating block and a temperature-limiting block connected to the heating block;
the temperature-limiting block comprises titanate and a substance containing a first doping element, and the temperature-limiting block is used for limiting a temperature of the electric heating film;
the first doping element is a rare earth element;
the substance containing the first doping element is an elementary substance containing the first doping element or a compound containing the first doping element.

2. The self-temperature-limiting electric heating film according to claim 1, wherein the temperature-limiting block is arranged on the substrate;
the heating block is arranged on the temperature-limiting block;
the two electrodes are arranged on the heating block.

3. The self-temperature-limiting electric heating film according to claim 1, wherein the electric heating layer comprises a heating block and two temperature-limiting blocks;
the heating block and the two temperature-limiting blocks are all arranged on the substrate, and the heating block is arranged between the two temperature-limiting blocks;
the two electrodes are arranged on the two temperature-limiting blocks respectively.

4. The self-temperature-limiting electric heating film according to claim 1, wherein the electric heating layer comprises a temperature-limiting block and two heating blocks;
the temperature-limiting block and the heating blocks are all arranged on the substrate, and the temperature-limiting block is arranged between the two heating blocks;
the two electrodes are arranged on the two heating blocks respectively.

5. The self-temperature-limiting electric heating film according to claim 1, wherein a mass ratio of the substance containing the first doping element and the titanate is 0.0015-0.003:1.

6. The self-temperature-limiting electric heating film according to claim 5, wherein the temperature limiting block further comprises a substance containing a second doping element, and the second doping element comprises at least one of a rare earth element, manganese, calcium and aluminum;
a mass ratio of the substance containing the second doping element and the titanate is 0:0.3-1;
the substance containing the second doping element is an elementary substance containing the second doping element or a compound containing the second doping element.

7. The self-temperature-limiting electric heating film according to claim 6, wherein the titanate is barium titanate, strontium titanate, barium strontium titanate or strontium lead titanate;
the rare earth element is at least one of lanthanum, cerium, neodymium, yttrium, praseodymium and samarium;
the substrate is made from glass, ceramic or plastic.

8. A preparation method for the self-temperature-limiting electric heating film according to claim 1, comprising:
depositing a substance containing a first doping element and titanate on a substrate to prepare a temperature-limiting block;
plating a heating block on a surface or side edge of the temperature-limiting block; and
arranging electrodes on the temperature-limiting block or the heating block to obtain the self-temperature-limiting electric heating film;
wherein, a mass ratio of the substance containing the first doping element and the titanate is 0.0015-0.003:1.

9. The preparation method for the self-temperature-limiting electric heating film according to claim 8, wherein the second temperature-limiting block further comprises a substance containing a second doping element;
correspondingly, depositing a substance containing a first doping element and titanate on a substrate to prepare a temperature-limiting block specifically comprises:
depositing the substance containing the first doping element, the substance containing the second doping element, and the titanate on the substrate to prepare the temperature-limiting block;
a mass ratio of the substance containing the second doping element and the titanate is 0-0.3:1.

10. The preparation method for the self-temperature-limiting electric heating film according to claim 8, wherein depositing a substance containing a first doping element and titanate on a substrate to prepare a temperature-limiting block specifically comprises:
depositing the substance containing the first doping element and the titanate on the substrate by one of a radio-frequency magneton sputtering method, a pulsed laser deposition method, a vacuum evaporation method, a molecular beam epitaxy method, a sol-gel method, a chemical vapor deposition method and a hydrothermal method to prepare the temperature-limiting block.

11. The self-temperature-limiting electric heating film according to claim 1, further comprising an infrared reflecting layer, wherein:
the heating block is arranged on a first surface of the substrate;
a heating material of the heating block is metal-oxide-semiconductor-heating material;
the infrared reflecting layer is arranged on a second surface of the substrate and is used for directionally reflecting heat transferred to the substrate to the heating block.

12. The self-temperature-limiting electric heating film according to claim 11, wherein the infrared reflecting layer comprises a first film and a second film;
the first film is arranged on the second surface of the substrate;
the second film is arranged on a surface of the first film;
a refraction index of the first film is greater than a refraction index of the second film.

13. The self-temperature-limiting electric heating film according to claim 11, further comprising a barrier layer, wherein:
the barrier layer is arranged between the heating block and the substrate and is used for preventing impurities and water vapor generated by the substrate from entering the heating block.

14. The self-temperature-limiting electric heating film according to claim 13, further comprising a smoothing layer, wherein:
the smoothing layer is arranged between the substrate and the barrier layer and is used for reducing roughness of the substrate.

15. The self-temperature-limiting electric heating film according to claim 14, further comprising a heat-resistant layer, wherein:
the heat-resistant layer is arranged between the smoothing layer and the barrier layer and is used for reducing a coefficient of thermal expansion of the substrate.

16. The preparation method for the self-temperature-limiting electric heating film according to claims 11, comprising:
plating a metal-oxide-semiconductor-heating material on a first surface of the substrate to form a heating block; and
plating an infrared reflecting layer on a second surface of the substrate, wherein the infrared reflecting layer is used for reflecting heat transferred to the substrate to the heating block.

17. The preparation method for the self-temperature-limiting electric heating film according to claim 16, wherein plating an infrared reflecting layer on a second surface of the substrate specifically comprises:
plating a first film on the second surface of the substrate; and
plating a second film on a surface of the first film;
wherein, a refraction index of the first film is greater than a refraction index of the second film.

18. The preparation method for the self-temperature-limiting electric heating film according to claim 17, wherein plating a first film on the second surface of the substrate specifically comprises:
plating the first film on the second surface of the substrate by a magnetron sputtering method;
plating a second film on a surface of the first film specifically comprises:
plating the second film on the surface of the first film by an electronic beam evaporation method.

19. The preparation method for the self-temperature-limiting electric heating film according to claim 16, wherein before plating a metal-oxide-semiconductor-heating material on a first surface of the substrate to form a heating block, the preparation method further comprises:
plating an oxide of a group IVA element on the first surface of the substrate to form a barrier layer;
correspondingly, plating a metal-oxide-semiconductor-heating material on a first surface of the substrate to form a heating block specifically comprises:
plating the metal-oxide-semiconductor-heating material on the barrier layer to form the heating block.

20. The preparation method for the self-temperature-limiting electric heating film according to claim 19, wherein before plating an oxide of a group IVA element on the first surface of the substrate to form a barrier layer, the preparation method further comprises:
coating acrylate on the first surface of the substrate to form a heat-resistant layer;
correspondingly, plating an oxide of a group IVA element on the first surface of the substrate to form a barrier layer specifically comprises:
plating the oxide of the group IVA element on the heat-resistant layer to form the barrier layer.
